(19) United States
(12) Patent Application Publication
(10) Pub. No.: US 2024/0403418 A1
(43) Pub. Date: Dec. 5, 2024

(54) VEHICLE SECURITY SYSTEM AND VEHICLE SECURITY DEVICE

(71) Applicant: Panasonic Automotive Systems Co., Ltd., Kanagawa (JP)

(72) Inventor: Jun ANZAI, Kanagawa (JP)

(73) Assignee: Panasonic Automotive Systems Co., Ltd., Kanagawa (JP)

(21) Appl. No.: 18/627,140

(22) Filed: Apr. 4, 2024

(30) Foreign Application Priority Data
Jun. 2, 2023 (JP) 2023-091388

(51) Int. Cl. G06F 21/55

(52) U.S. Cl. CPC G06F 21/554; G06F 2221/034

(57) ABSTRACT

A vehicle security system includes: a primary dynamic authenticator disposed in an integrated electronic control unit (ECU) in the vehicle; and one or more connection managers. In the vehicle security system, when an access request for access to an access destination in the vehicle is made by an access source in the vehicle, the primary dynamic authenticator dynamically performs authentication of the access request based on a state of the vehicle, and causes a connection manager located on a communication path between the access source and the access destination, among the one or more connection managers, to control a connection between the access source and the access destination, based on a result of the authentication of the access request.

### CROSS REFERENCE TO RELATED APPLICATION

The present application is based on and claims priority of Japanese Patent Application No. 2023-091388 filed on Jun. 2, 2023.

### FIELD

The present disclosure relates to a vehicle security system and a vehicle security device provided in a vehicle.

### BACKGROUND

With the development of CASE which stands for “Connected, Autonomous, Shared & Services, Electric” for vehicles, networks such as Controller Area Network (CAN) or Ethernet (registered trademark) inside a vehicle are increasingly connected to smartphones and external servers through networks outside the vehicle such as Wi-Fi (registered trademark), Bluetooth (registered trademark), Cellular, and V2X which stands for “Vehicle to X”. For example, there are many instances where electric vehicles are connected cars in order to manage their charging status, and if manipulated improperly, the battery could fall in a dangerous state. Therefore, countermeasures against external threats to the vehicle are needed.

For example, Patent Literature (PTL) 1 discloses a method for detecting intrusions of threats into an in-vehicle network.

### CITATION LIST

### Patent Literature

PTL 1: Japanese Unexamined Patent Application Publication No. 2014-146868

### SUMMARY

### Technical Problem

However, the above-described system disclosed by PTL 1 can be improved upon.

In view of this, the present disclosure provides a vehicle security system, etc. which are capable of improving upon the above related art.

### Solution to Problem

A vehicle security system according to one aspect of the present disclosure is a vehicle security system provided in a vehicle, the vehicle security system including: a primary dynamic authenticator disposed in an electronic control unit (ECU) in the vehicle; and one or more connection managers. In the vehicle security system, when an access request for access to an access destination in the vehicle is made by an access source in the vehicle, the primary dynamic authenticator dynamically performs authentication of the access request based on a state of the vehicle, and causes a connection manager located on a communication path between the access source and the access destination, among the one or more connection managers, to control a connection between the access source and the access destination, based on a result of the authentication of the access request.

A vehicle security device according to another aspect of the present disclosure is a vehicle security device provided in a vehicle, the vehicle security device including: a primary dynamic authenticator. In the vehicle security device, the primary dynamic authenticator dynamically performs, based on a state of the vehicle, authentication of an access request made by an access source in the vehicle for access to an access destination in the vehicle, and causes a connection manager located on a communication path between the access source and the access destination, among one or more connection managers disposed in the vehicle, to control a connection between the access source and the access destination, based on a result of the authentication of the access request.

A vehicle security device according to yet another aspect of the present disclosure is a vehicle security device provided in a vehicle, the vehicle security device including: a secondary dynamic authenticator. In the vehicle security device, when the vehicle security device is located on a communication path between an access source in the vehicle and an access destination in the vehicle, the secondary dynamic authenticator dynamically performs authentication of an access request made by the access source for access to the access destination, based on a state of the vehicle, and causes a connection manager located on the communication path between the access source and the access destination, among one or more connection managers disposed in the vehicle, to control a connection between the access source and the access destination, based on a result of the authentication of the access request.

General and specific aspects disclosed above may be implemented using a system, a method, an integrated circuit, a computer program, or a computer-readable recording medium such as a compact disc read only memory (CD-ROM), or any combination of systems, methods, integrated circuits, computer programs, or computer-readable recording media.

### Advantageous Effects

With the vehicle security system according to one aspect of the present disclosure, etc., it is possible to improve upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram illustrating an example of a vehicle security system according to Embodiment 1.

FIG. 2 is a block diagram illustrating an example of a vehicle security system according to Embodiment 2.

FIG. 3 is a block diagram illustrating an example of a vehicle security system according to Embodiment 3.

FIG. 4 is a block diagram illustrating an example of a vehicle security system according to Embodiment 4.

### DESCRIPTION OF EMBODIMENTS

PTL 1 describes a method for detecting the intrusion of a threat into an in-vehicle network. However, if detection of the intrusion of a threat into the in-vehicle network fails, the threat may cause damage.

In view of the above, the following describes a vehicle security system, etc. which are capable of inhibiting damage even when a threat intrudes into the in-vehicle network.

Hereinafter, embodiments are specifically described with reference to the drawings.

It should be noted that the embodiments described below each show a general or specific example. The numerical values, shapes, materials, structural elements, the arrangement and connection of the structural elements, etc. shown in the following exemplary embodiments are mere examples, and therefore do not limit the scope of the present disclosure.

### Embodiment 1

Hereinafter, a vehicle security system and a vehicle security device according to Embodiment 1 will be described.

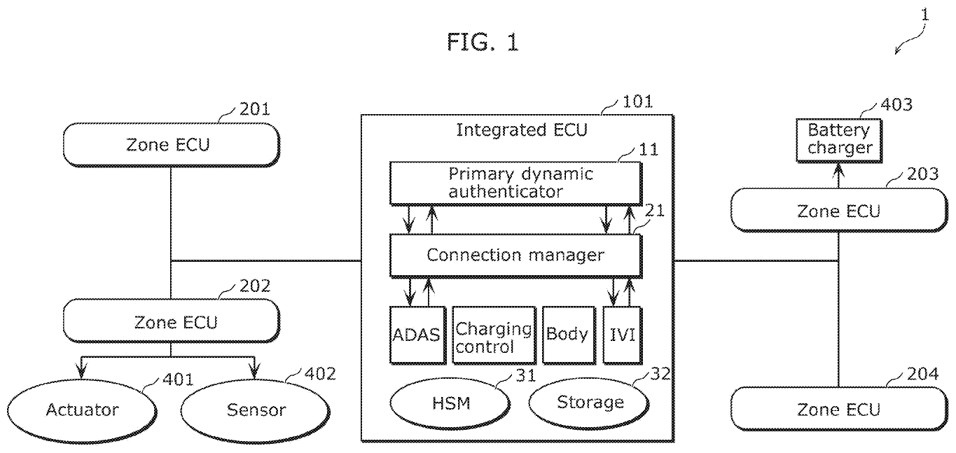

FIG. 1 is a block diagram illustrating an example of vehicle security system 1 according to Embodiment 1. Vehicle security system 1 is provided in a vehicle. For example, vehicle security system 1 needs only include at least primary dynamic authenticator 11 and one or more connection managers, and thus integrated electronic control unit (ECU) 101, zone ECUs 201, 202, 203, and 204, actuator 401, sensor 402, and battery charger 403, all of which are disposed in the vehicle need not necessarily be structural elements of vehicle security system 1.

Vehicle security system 1 is a system for applying a zero trust architecture to the vehicle. The zero trust architecture is, for example, Special Publication (SP) 800-207 Zero Trust Architecture by the National Institute of Standards and Technology (NIST). When the zero trust architecture is applied to a vehicle, authentication is dynamically performed for each access request made by various resources included in the vehicle. In order to dynamically perform authentication of access requests, vehicle security system 1 includes primary dynamic authenticator 11 and one or more connection managers. A dynamic authenticator is an example of a policy decision point (PDP) in the zero trust architecture, and the connection manager is an example of a policy enforcement point (PEP) in the zero trust architecture. For example, the one or more connection managers include connection manager 21 included in integrated ECU 101.

FIG. 1 illustrates: integrated ECU 101; zone ECUs 201, 202, 203, and 204 which are connected to integrated ECU 101, actuator 401 and sensor 402 which are connected to zone ECU 202, and battery charger 403 connected to zone ECU 203, all of which are disposed in the vehicle.

Integrated ECU 101 is the ECU that controls the entire vehicle, serving as the center of zone ECUs 201, 202, 203, 204, etc. Integrated ECU 101 is an example of the vehicle security device provided in the vehicle. Integrated ECU 101 is a central ECU in which a plurality of ECUs are integrated and may, for example, have a security function. Integrated ECU 101 includes primary dynamic authenticator 11 and connection manager 21. Integrated ECU 101 is an example of the ECU in which primary dynamic authenticator 11 is disposed. In addition, for example, integrated ECU 101 includes hardware security module (HSM) 31 and storage 32.

Integrated ECU 101 is a computer including a processor (microprocessor), memory, etc. Memory is read only memory (ROM), random access memory (RAM), or the like, and is capable of storing programs executed by a processor. Primary dynamic authenticator 11 and connection manager 21 are implemented by a processor or the like which executes a program stored in the memory. In addition, for example, integrated ECU 101 may have functions (applications) for the advanced driver assistance system (ADAS), charging control, body control, and the in-vehicle infotainment (IVI) control, and these functions (applications) are also implemented by the processor or the like which executes the program stored in the memory.

Zone ECUs 201, 202, 203, and 204 are each disposed, for example, in a corresponding one of the front, rear, left, and right regions of the vehicle, and controls a resource in the region in which it is disposed. For example, zone ECU 202 controls actuator 401 and sensor 402, and zone ECU 203 controls battery charger 403.

Zone ECUs 201, 202, 203 and 204 are each a computer including a processor (microprocessor), memory, etc. Memory is ROM, RAM, or the like, and is capable of storing programs executed by the processor. For example, the functions of zone ECUs 201, 202, 203 and 204 to control resources (e.g., actuator 401, sensor 402, battery charger 403, etc.) connected to zone ECUs 201, 202, 203 and 204 are implemented by a processor or the like which executes a program stored in the memory.

When an access request for access to an access destination in the vehicle is made by an access source in the vehicle, primary dynamic authenticator 11 dynamically performs authentication of the access request (specifically, determines whether the access request is permissible or not) based on a state of the vehicle, and causes a connection manager (in the case of vehicle security system 1, connection manager 21), among one or more connection managers, which is located on a communication path between the access source and the access destination to control a connection between the access source and the access destination, based on a result of the authentication of the access request. More specifically, the authentication of an access request is performed based on a policy that describes which access source is permitted to access to which access destination when the vehicle is in what state. In addition, as described below, even once a connection is permitted, whether a policy condition is satisfied is periodically checked, and if the policy condition is not satisfied, authentication is performed once again or the connection is released.

Connection manager 21 controls a connection between the resources that perform communication via connection manager 21.

For example, access requests made by the resources in the vehicle may or may not be permitted depending on a state of the vehicle, and thus whether an access request is permissible is determined in consideration of the state of the vehicle. For example, the state of a vehicle includes a usage status of the access destination, a driving state of the vehicle, a security status of the access source, a security status of the access destination, a usage status of a service used in the vehicle, or a state of the access destination.

For example, when the usage status of the access destination indicates that the access destination is in use, the access request is not permitted and the access source and the access destination are not connected. For example, when the usage status of the access destination indicates that the access destination is not in use, the access request is permitted and the access source and the access destination are connected. It should be noted that, for example, the access source and the access destination may be connected even when the usage status of the access destination indicates that the access destination is in use. In this case, the access source can use the access destination as soon as the access destination is available. In other words, even when the access source and the access destination are connected, the access source cannot use the access destination until the access destination becomes available. For example, when the usage status of the access destination indicates that the access destination is in use but is available, the access request is permitted and the access source and the access destination are connected. However, when the resource currently using the access destination and the access source that has made the access request cannot use the access destination at the same time (when they compete with each other), the access request is not permitted and the access source and the access destination are not connected.

For example, when the driving state of the vehicle indicates that the vehicle is stopped and the access destination is a resource that can be used even when the vehicle is stopped, the access request is permitted and the access source and the access destination are connected. For example, when the driving state of the vehicle indicates that the vehicle is stopped and the access destination is a resource that cannot be used when the vehicle is stopped, the access request is not permitted and the access source and the access destination are not connected. For example, when the driving state of the vehicle indicates that the vehicle is moving and the access destination is a resource that can be used even when the vehicle is moving, the access request is permitted and the access source and the access destination are connected. For example, when the driving state of the vehicle indicates that the vehicle is moving and the access destination is a resource that cannot be used when the vehicle is moving, the access request is not permitted and the access source and the access destination are not connected.

For example, when the security status of the access source indicates that the access source is in a non-attacked state or a non-vulnerable state, the access request is permitted and the access source and the access destination are connected. For example, when the security status of the access source indicates that the access source is in an under-attack state or a vulnerable state, the access request is not permitted and the access source and the access destination are not connected.

For example, when the security status of the access destination indicates that the access destination is in a non-attacked state or a non-vulnerable state, the access request is permitted and the access source and the access destination are connected. For example, when the security status of the access destination indicates that the access destination is in an under-attack state or a vulnerable state, the access request is not permitted and the access source and the access destination are not connected.

For example, when the access destination provides a specific service and, as the usage status of this specific service used in the vehicle, a contract is in force or the access source satisfies the terms and conditions of the access destination, the access request is permitted and the access source and the access destination are connected. For example, when the access destination provides a specific service and, as the usage status of this specific service used in the vehicle, a contract is not in force or the access source does not satisfy the terms and conditions of the access destination, the access request is not permitted and the access source and the access destination are not connected.

For example, when the state of the access destination indicates that the battery is low, and a request which involves power consumption such as a request for content reproduction is made by the access source, the access request is not permitted and the access source and access point are not connected.

As described above, when determining that the state of the vehicle satisfies a predetermined condition, primary dynamic authenticator 11 causes connection manager 21 located on a communication path between the access source and the access destination to connect the access source and the access destination. For example, when determining that the state of the vehicle no longer satisfies a predetermined condition, primary dynamic authenticator 11 causes connection manager 21 located on the communication path between the access source and the access destination to disconnect the connection between the access source and the access destination. For example, when determining that the state of the vehicle no longer satisfies a predetermined condition, primary dynamic authenticator 11 may once again perform authentication of the access request, and if the authentication of the access request once again performed fails, primary dynamic authenticator 11 may cause connection manager 21 located on the communication path between the access source and the access destination to disconnect the connection between the access source and the access destination.

Since connection manager 21 located on the communication path between the access source and the access destination is capable of controlling the connection between the access source and the access destination, primary dynamic authenticator 11 is capable of controlling the connection between the access source and the access destination via connection manager 21, based on whether the state of the vehicle satisfies the predetermined condition. In addition, since primary dynamic authenticator 11 once again performs authentication of the access request when determining that the state of the vehicle no longer satisfies the predetermined condition, it is possible to inhibit the connection between the access source and the access destination from being disconnected when the state of the vehicle temporarily changes and the state of the vehicle temporarily fails to satisfy the predetermined condition.

The following describes, for example, the case where the access source is the ADAS function (application) of integrated ECU 101 and the access destination is actuator 401. In this case, since connection manager 21 is located on the communication path between the access source and the access destination, connection manager 21 controls the connection between the ADAS function of integrated ECU 101 and actuator 401.

First, the ADAS function of integrated ECU 101 makes an access request for access to actuator 401, to primary dynamic authenticator 11 via connection manager 21. Primary dynamic authenticator 11 determines whether the access request from the ADAS function of integrated ECU 101 is permissible, based on the state of the vehicle. When primary dynamic authenticator 11 permits the access request, primary dynamic authenticator 11 causes connection manager 21 to connect actuator 401 and the ADAS function of integrated ECU 101 (in other words, causes connection manager 21 to establish a session between actuator 401 and the ADAS function of integrated ECU 101).

The following describes, for example, the case where the access source is the IVI control function (application) of integrated ECU 101 and the access destination is storage 32 of integrated ECU 101 In this case, since connection manager 21 is located on the communication path between the access source and the access destination, connection manager 21 controls the connection between the IVI control function of integrated ECU 101 and storage 32.

First, the IVI control function of integrated ECU 101 makes an access request for access to storage 32, to primary dynamic authenticator 11 via connection manager 21. Primary dynamic authenticator 11 determines whether the access request from the IVI control function of integrated ECU 101 is permissible, based on the state of the vehicle. When primary dynamic authenticator 11 permits the access request, primary dynamic authenticator 11 causes connection manager 21 to connect storage 32 and the IVI control function of integrated ECU 101 (in other words, causes connection manager 21 to establish a session between storage 32 and the IVI control function of integrated ECU 101).

In this manner, when integrated ECU 101 is located on the communication path between an access source and an access destination, primary dynamic authenticator 11 may cause connection manager 21 disposed in integrated ECU 101 to control the connection between the access source and the access destination.

As described above, since the so-called zero trust architecture, which dynamically performs authentication of an access request; that is, authentication is performed for each access request on the assumption that a threat has already entered a vehicle, is applied to the vehicle, even if a threat has entered an in-vehicle network, it is possible to inhibit damage because the threat can be detected as a result of dynamically performing authentication of the access request. For example, it is possible to inhibit a vehicle which threat has entered from falling in a dangerous state, and inhibit an external network from being attacked due to the vehicle which threat has entered being used as a starting point for the attack on the external network.

For example, primary dynamic authenticator 11 may obtain vehicle state information indicating the state of the vehicle via any of one or more connection managers. When primary dynamic authenticator 11 obtains vehicle state information, authentication of an access request for access to a resource which holds the vehicle state information is also performed, and the vehicle state information is obtained via one or more connection managers. As a result, it is possible to improve security. It should be noted that, primary dynamic authenticator 11 may directly obtain vehicle state information from the resource which holds the vehicle state information, without involving any of the one or more connection managers. Alternatively, a vehicle state information manager that obtains and manages vehicle state information from a resource which holds the vehicle state information may be disposed in the vehicle, and primary dynamic authenticator 11 may obtain the vehicle state information from the vehicle state information manager.

For example, the usage status of an access destination can be obtained from an access destination or the like. For example, the driving state of a vehicle can be obtained from integrated ECU 101, the ADAS ECU, or the like. For example, the security status of an access source and the security status of an access destination can be obtained from an intrusion detection system (IDS) or the like. For example, the usage status of a service used in a vehicle can be obtained from a service manager that manages services or the like. For example, integrated ECU 101 may have a function of the service manager.

### Embodiment 2

Next, a vehicle security system and a vehicle security device according to Embodiment 2 will be described.

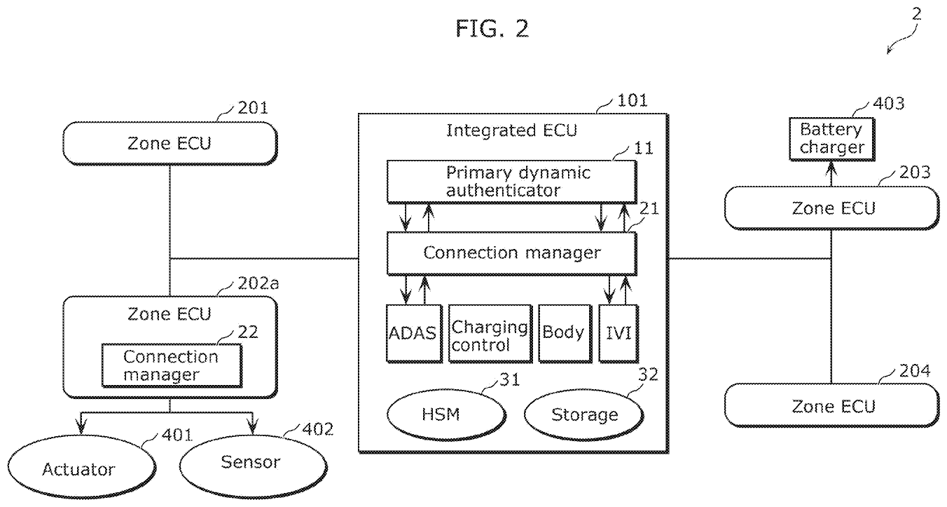

FIG. 2 is a block diagram illustrating an example of vehicle security system 2 according to Embodiment 2. According to Embodiment 2, vehicle security system 2 includes connection manager 21 disposed in integrated ECU 101 and connection manager 22 disposed in zone ECU 202a as one or more connection managers. Other points are basically the same as vehicle security system 1 and the vehicle security device (integrated ECU 101) according to Embodiment 1. Accordingly, the same descriptions are omitted, and the following description focuses on the different points.

Connection manager 22 controls a connection between the resources that perform communication via connection manager 22. Connection manager 22 is implemented by a processor or the like that executes a program stored in the memory in zone ECU 202a.

When determining that a state of the vehicle satisfies a predetermined condition, primary dynamic authenticator 11 causes connection manager 22 located on a communication path between an access source and an access destination to connect the access source and the access destination. For example, when determining that a state of the vehicle no longer satisfies a predetermined condition, primary dynamic authenticator 11 causes connection manager 22 located on a communication path between the access source and the access destination to disconnect the connection between the access source and the access destination. At this time, when determining that a state of the vehicle no longer satisfies a predetermined condition, primary dynamic authenticator 11 may once again perform authentication of the access request, and if the authentication of the access request once again performed fails, primary dynamic authenticator 11 may cause connection manager 22 located on a communication path between the access source and the access destination to disconnect the connection between the access source and the access destination.

The following describes, for example, the case where the access source is the ADAS function (application) of integrated ECU 101 and the access destination is actuator 401. In this case, since connection manager 22 is located on the communication path between the access source and the access destination, connection manager 22 controls the connection between the ADAS function of integrated ECU 101 and actuator 401.

First, the ADAS function of integrated ECU 101 makes an access request for access to actuator 401, to primary dynamic authenticator 11 via connection manager 21. Primary dynamic authenticator 11 determines whether the access request from the ADAS function of integrated ECU 101 is permissible, based on the state of the vehicle. When primary dynamic authenticator 11 permits the access request, primary dynamic authenticator 11 causes connection manager 22 to connect actuator 401 and the ADAS function of integrated ECU 101 (in other words, causes connection manager 22 to establish a session between actuator 401 and the ADAS function of integrated ECU 101).

The following describes, for example, the case where the access source is the IVI control function (application) of integrated ECU 101 and the access destination is storage 32 of integrated ECU 101 In this case, since connection manager 21 is located on the communication path between the access source and the access destination, connection manager 21 controls the connection between the IVI control function of integrated ECU 101 and storage 32.

First, the IVI control function of integrated ECU 101 makes an access request for access to storage 32, to primary dynamic authenticator 11 via connection manager 21. Primary dynamic authenticator 11 determines whether the access request from the IVI control function of integrated ECU 101 is permissible, based on the state of the vehicle. When primary dynamic authenticator 11 permits the access request, primary dynamic authenticator 11 causes connection manager 21 to connect storage 32 and the IVI control function of integrated ECU 101 (in other words, causes connection manager 21 to establish a session between storage 32 and the IVI control function of integrated ECU 101).

In this manner, when zone ECU 202a is located on the communication path between an access source and an access destination, primary dynamic authenticator 11 may cause connection manager 22 disposed in zone ECU 202a to control the connection between the access source and the access destination.

### Embodiment 3

Next, a vehicle security system and a vehicle security device according to Embodiment 3 will be described.

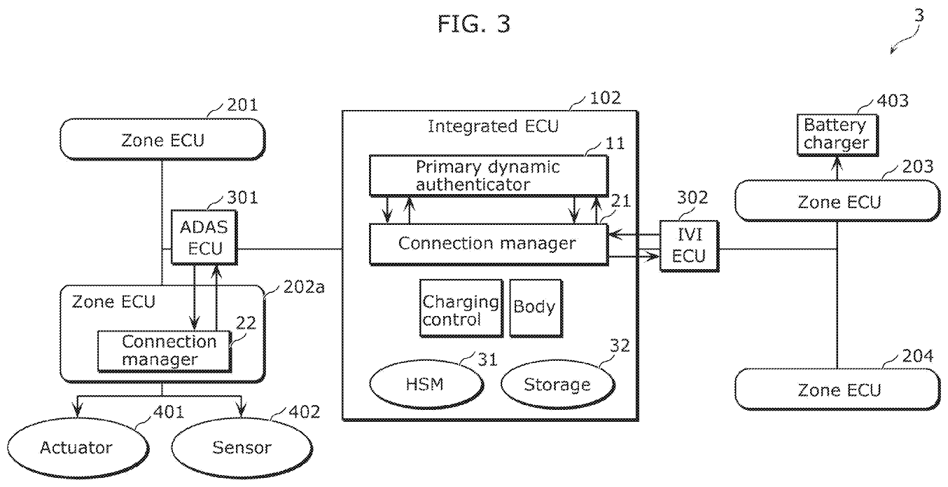

FIG. 3 is a block diagram illustrating an example of vehicle security system 3 according to Embodiment 3. According to Embodiment 3, vehicle security system 3 includes integrated ECU 102 in place of integrated ECU 101. Other points are basically the same as vehicle security system 2 and the vehicle security device (integrated ECU 101) according to Embodiment 2. Accordingly, the same descriptions are omitted, and the following description focuses on the different points.

Integrated ECU 102 is different from integrated ECU 101 in that integrated ECU 102 does not include the ADAS function and the IVI control function. Other points are the same as integrated ECU 101, and thus the same descriptions are omitted. Since integrated ECU 102 does not include the ADAS function and the IVI control function, ADAS ECU 301 and IVI ECU 302 are disposed in the vehicle. For example, ADAS ECU 301 is controlled by zone ECU 202a, and IVI ECU 302 is controlled by integrated ECU 102.

The following describes, for example, the case where the access source is ADAS ECU 301 and the access destination is actuator 401. In this case, since connection manager 22 is located on the communication path between the access source and the access destination, connection manager 22 controls the connection between ADAS ECU 301 and actuator 401.

First, ADAS ECU 301 makes an access request for access to actuator 401, to primary dynamic authenticator 11 via connection manager 22. Primary dynamic authenticator 11 determines whether the access request from ADAS ECU 301 is permissible, based on the state of the vehicle. When primary dynamic authenticator 11 permits the access request, primary dynamic authenticator 11 causes connection manager 22 to connect actuator 401 and ADAS ECU 301 (in other words, causes connection manager 22 to establish a session between actuator 401 and ADAS ECU 301).

The following describes, for example, the case where the access source is IVI ECU 302 and the access destination is storage 32 of integrated ECU 101. In this case, since connection manager 21 is located on the communication path between the access source and the access destination, connection manager 21 controls the connection between IVI ECU 302 and storage 32.

First, IVI ECU 302 makes an access request for access to storage 32, to primary dynamic authenticator 11 via connection manager 21. Primary dynamic authenticator 11 determines whether the access request from IVI ECU 302 is permissible, based on the state of the vehicle. When primary dynamic authenticator 11 permits the access request, primary dynamic authenticator 11 causes connection manager 21 to connect storage 32 and IVI ECU 302 (in other words, causes connection manager 21 to establish a session between storage 32 and IVI ECU 302).

### Embodiment 4

Next, a vehicle security system and a vehicle security device according to Embodiment 4 will be described.

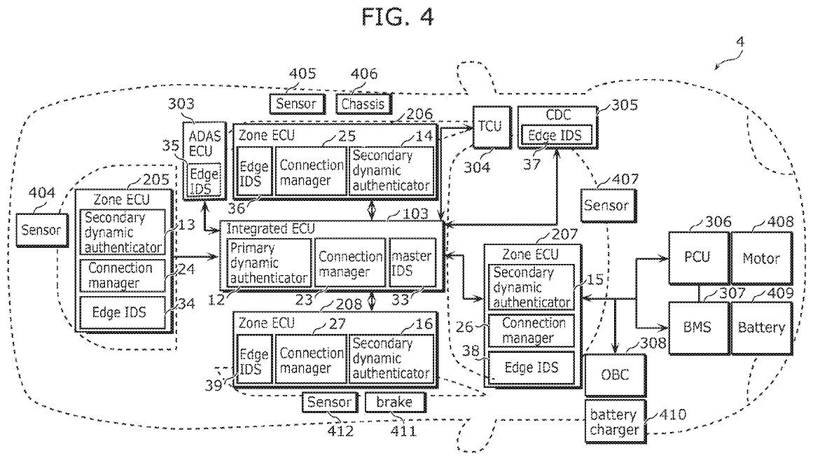

FIG. 4 is a block diagram illustrating an example of vehicle security system 4 according to Embodiment 4. Vehicle security system 4 is provided in a vehicle. For example, vehicle security system 4 needs only include at least primary dynamic authenticator 12, one or more secondary dynamic authenticators, and one or more connection managers, and thus integrated ECU 103, zone ECUs 205, 206, 207, and 208, ADAS ECU 303, telematics control unit (TCU) 304, cockpit domain controller (CDC) 305, power control unit (PCU) 306, battery management system (BMS) 307, on board charger (OBC) 308, sensors 404, 405, 407, and 412, chassis 406, motor 408, battery 409, battery charger 410, and brake 411, all of which are disposed in the vehicle need not necessarily be structural elements of vehicle security system 1.

Vehicle security system 4 is a system for applying a zero trust architecture to vehicles, as with vehicle security systems 1 to 3. In order to dynamically perform authentication of access requests, vehicle security system 4 includes primary dynamic authenticator 12, one or more secondary dynamic authenticators, and one or more connection managers. For example, the one or more secondary dynamic authenticators include secondary dynamic authenticators 13, 14, 15, and 16 respectively included in zone ECUs 205, 206, 207, and 208. For example, the one or more connection managers include connection manager 23 included in integrated ECU 101, and connection managers 24, 25, 26, and 27 respectively included in zone ECUs 205, 206, 207, and 208.

FIG. 4 illustrates: integrated ECU 103; zone ECUs 205, 206, 207, and 208, ADAS ECU 303, TCU 304, and CDC 305 which are connected to integrated ECU 103; sensor 404 controlled by zone ECU 205; sensor 405 and chassis 406 which are controlled by zone ECU 206; sensor 407, PCU 306, BMS 307, and OBC 308 which are controlled by zone ECU 207; brake 411 and sensor 412 which are controlled by zone ECU 208; motor 408 controlled by PCU 306; battery 409 controlled by BMS 307; and battery charger 410 controlled by OBC 308, all of which are disposed in the vehicle.

Integrated ECU 103 is the ECU that controls the entire vehicle, serving as the center of zone ECUs 205, 206, 207, 208, etc. Integrated ECU 103 is an example of the vehicle security device disposed in the vehicle. Integrated ECU 103 includes primary dynamic authenticator 12, connection manager 23, and master IDS 33. Integrated ECU 103 is an example of the ECU in which primary dynamic authenticator 12 is disposed.

Integrated ECU 103 is a computer including a processor (microprocessor), memory, etc. Memory is ROM, RAM, or the like, and is capable of storing programs executed by a processor. Primary dynamic authenticator 12 and connection manager 23 are implemented by a processor or the like which executes the program stored in the memory.

Zone ECUs 205, 206, 207, and 208 are each disposed, for example, in a corresponding one of the front, rear, left, and right regions of the vehicle, and controls a resource in the region in which it is disposed. For example, zone ECU 205 includes: secondary dynamic authenticator 13; connection manager 24; and edge IDS 34, and controls sensor 404. For example, zone ECU 206 includes: secondary dynamic authenticator 14; connection manager 25; and edge IDS 36, and controls sensor 405 and chassis 406. For example, zone ECU 207 includes: secondary dynamic authenticator 15; connection manager 26; and edge IDS 38, and controls sensor 407, PCU 306, BMS 307, and OB 308. For example, zone ECU 208 includes: secondary dynamic authenticator 16; connection manager 27; and edge IDS 39, and controls brake 411 and sensor 412.

Zone ECUs 205, 206, 207, and 208 are each a computer including a processor (microprocessor), memory, etc. Memory is ROM, RAM, or the like, and is capable of storing programs executed by a processor. Secondary dynamic authenticators 13, 14, 15, and 16 and connection managers 24, 25, 26, and 27 are implemented by a processor or the like which executes the program stored in the memory. For example, the functions of zone ECUs 205, 206, 207, and 208 to control sensors 404, 405, 407, and 412, chassis 406, brake 411, PCU 306, BMS 307, and OBC 308 are implemented by a processor or the like which executes the program stored in the memory.

ADAS ECU 303 is an ECU for assisting the driver of a vehicle in driving operations. For example, ADAS ECU 303 includes edge IDS 35.

TCU 304 is a communication unit for performing the communication between the vehicle and an external network in response to a request from integrated ECU 103.

CDC 305 is a controller that controls the screens disposed in the vehicle (an IVI display, a meter display, a head-up display, etc.). For example, CDC 305 includes edge IDS 37.

PCU 306 is a unit that includes an inverter and a DC-DC converter, etc., and controls the power supply to motor 408.

BMS 307 is a system for managing battery 409. Battery 409, which is a lithium-ion battery or the like, is a hazardous component and thus need to be managed by BMS 307.

OBC 308 converts AC power supplied by battery charger 410 to DC power and charges battery 409.

When an access request is made by an access source in a vehicle for access to an access destination in the vehicle, primary dynamic authenticator 12 dynamically performs authentication of the access request (specifically, determines whether the access request is permissible or not) based on a state of the vehicle, and causes a connection manager (for example, any of connection managers 23, 24, 25, 26, and 27), among one or more connection managers, which is located on a communication path between the access source and the access destination to control a connection between the access source and the access destination, based on a result of the authentication of the access request.

In the case where zone ECU 205, 206, 207 or 208 is located on a communication path between the access source and the access destination, when an access request is made by an access source for access to an access destination, secondary dynamic authenticator 13, 14, 15 or 16 dynamically performs authentication of the access request (specifically, determines whether the access request is permissible or not) based on the state of the vehicle, and causes a connection manager (for example, any of connection managers 23, 24, 25, 26, and 27), among one or more connection managers, which is located on the communication path between the access source and the access destination to control a connection between the access source and the access destination, based on a result of the authentication of the access request. In other words, according to Embodiment 4, primary dynamic authenticator 12 need not necessarily perform authentication of an access request as in Embodiments 1 to 3, and when (i) zone ECU 205, 206, 207 or 208 is located on the communication path between the access source and the access destination, and (ii) integrated ECU 103 is not located on the communication path between the access source and the access destination, secondary dynamic authenticator 13, 14, 15 or 16 performs authentication of the access request.

Connection managers 23, 24, 25, 26, and 27 each control a connection between the resources that perform communication via itself.

Each of the edge IDSs detects an attack on a resource in the region corresponding to the ECU in which the edge IDS is included. Master IDS 33 collects detection results from each of the edge IDSs and detects an attack in the entire vehicle.

As described in Embodiment 1, for example, whether an access request is permissible is determined in consideration of the state of the vehicle, and the state of the vehicle includes a usage status of the access destination, a driving state of the vehicle, a security status of the access source, a security status of the access destination, and a usage status of a service used in the vehicle.

When determining that the state of the vehicle satisfies a predetermined condition, the secondary dynamic authenticator included in the zone ECU located on the communication path between an access source and an access destination causes the connection manager located on the communication path between the access source and the access destination to connect the access source and the access destination. When determining that a state of the vehicle no longer satisfies a predetermined condition, the secondary dynamic authenticator causes the connection manager located on a communication path between the access source and the access destination to disconnect the connection between the access source and the access destination. For example, when determining that the state of the vehicle no longer satisfies a predetermined condition, the secondary dynamic authenticator may once again perform authentication of the access request, and if the authentication of the access request once again performed fails, the secondary dynamic authenticator may cause the connection manager located on the communication path between the access source and the access destination to disconnect the connection between the access source and the access destination.

The connection manager located on the communication path between an access source and an access destination is capable of controlling the connection between the access source and the access destination, and thus the secondary dynamic authenticator is capable of controlling the connection between the access source and the access destination via the connection manager, based on whether the state of the vehicle satisfies a predetermined condition In addition, since the secondary dynamic authenticator once again performs authentication of the access request when determining that the state of the vehicle no longer satisfies the predetermined condition, it is possible to inhibit the connection between the access source and the access destination from being disconnected when the state of the vehicle temporarily changes and the state of the vehicle temporarily fails to satisfy the predetermined condition.

The following describes, for example, the case where the access source is a communication control function (not illustrated) of integrated ECU 103 with an external network, and the access destination is TCU 304. In this case, since connection manager 23 is located on the communication path between the access source and the access destination, connection manager 23 controls the connection between the communication control function of integrated ECU 103 and TCU 304.

First, the communication control function of integrated ECU 103 makes an access request for access to TCU 304, to primary dynamic authenticator 12 via connection manager 23. Primary dynamic authenticator 12 determines whether the access request from the communication control function of integrated ECU 103 is permissible, based on the state of the vehicle. When primary dynamic authenticator 12 permits the access request, primary dynamic authenticator 12 causes connection manager 23 to connect TCU 304 and the communication control function of integrated ECU 103 (in other words, causes connection manager 23 to establish a session between TCU 304 and the communication control function).

In this manner, when an access request to access TCU 304 is made for transmitting information to the external network, primary dynamic authenticator 12 dynamically performs authentication of the access request, and thus it is possible to inhibit an external network from being attacked due to a vehicle which threat has entered being used as a starting point for the attack on the external network.

In addition, since battery charger 410 is also connected to an external network (e.g., home charger or public charger), the vehicle can be used as a starting point for the attack on the external network via battery charger 410. However, when an access request for access to battery charger 410 is made, authentication of the access request for access to battery charger 410 is dynamically performed, and thus it is possible to inhibit an external network from being attacked due to a vehicle which threat has entered being used as a starting point for the attack on the external network.

The following describes, for example, the case where the access source is OBC 308 and the access destination is BMS 307. In this case, since connection manager 26 disposed in zone ECU 207 is located on the communication path between the access source and the access destination, connection manager 26 controls the connection between OBC 308 and BMS 307.

First, OBC 308 makes an access request for access BMS 307, to secondary dynamic authenticator 15 via connection manager 26. secondary dynamic authenticator 15 determines whether the access request from OBC 308 is permissible, based on the state of the vehicle. When secondary dynamic authenticator 15 permits the access request, secondary dynamic authenticator 15 causes connection manager 26 to connect OBC 308 and BMS 307 (in other words, causes connection manager 26 to establish a session between OBC 308 and BMS 307).

For example, access requests made by resources in a vehicle include access requests related to controls that must be performed immediately, such as acceleration, deceleration, stopping, right turns, and left turns, which require high responsiveness in authentication of access requests. In view of the above, vehicle security system 4 include, in addition to primary dynamic authenticator 12 disposed in integrated ECU 103, secondary dynamic authenticators 13, 14, 15, and 16 which are disposed in zone ECUs 205, 206, 207, and 208, respectively. According to this configuration, when zone ECU 205, 206, 207, or 208 is located on the communication path between the access source and the access destination, it is possible to perform authentication of an access request by secondary dynamic authenticator 13, 14, 15, or 16 in proximity to the access source. As a result, it is possible to improve the responsiveness in authentication of the access request.

The authentication of an access request to a resource not controlled by zone ECUs 205, 206, 207, and 208 (e.g., ADAS ECU 303, TCU 304, or CDC 305) is performed by primary dynamic authenticator 12. In addition, the authentication of an access request from a resource in one zone ECU to a resource in another zone ECU is performed by primary dynamic authenticator 12 because integrated ECU 103 is located between these zone ECUs.

For example, primary dynamic authenticator 12 may obtain vehicle state information indicating the state of the vehicle via any of one or more connection managers. When primary dynamic authenticator 12 obtains vehicle state information, authentication of an access request for access to a resource which holds the vehicle state information is also performed, and the vehicle state information is obtained via one or more connection managers. As a result, it is possible to improve security. It should be noted that, primary dynamic authenticator 12 may directly obtain vehicle state information from the resource which holds the vehicle state information, without involving any of the one or more connection managers. Alternatively, a vehicle state information manager that obtains and manages vehicle state information from a resource which holds the vehicle state information may be disposed in the vehicle, and primary dynamic authenticator 12 may obtain vehicle state information from the vehicle state information manager.

For example, the usage status of an access destination can be obtained from an access destination or the like. For example, the driving state of a vehicle can be obtained from integrated ECU 103, ADAS ECU 303 or the like. For example, the security status of an access source and the security status of an access destination can be obtained from an IDS or the like. For example, the usage status of a service used in a vehicle can be obtained from a service manager that manages services or the like. For example, integrated ECU 103 may have a function of the service manager.

For example, integrated ECU 103 and zone ECUs 205, 206, 207, and 208 holds vehicle state information indicating the state of the vehicle, and primary dynamic authenticator 12 causes secondary dynamic authenticators 13, 14, 15, and 16 to update, at a predetermined time, the vehicle state information held in zone ECUs 205, 206, 207, and 208 with latest vehicle state information held in integrated ECU 103. Then, secondary dynamic authenticators 13, 14, 15, and 16 dynamically perform authentication of the access request from the access source to the access destination, based on the state of the vehicle indicated by the vehicle state information held in zone ECUs 205, 206, 207, and 208.

Since vehicle state information held in zone ECUs 205, 206, 207, and 208 is updated at a predetermined time (e.g., periodically, when security information is updated, or when an anomaly occurs) with the latest vehicle state information held in integrated ECU 103, secondary dynamic authenticators 13, 14, 15, and 16 are capable of performing authentication of access requests with high accuracy, using the vehicle state information that has been updated.

### OTHER EMBODIMENTS

Embodiments are described thus far as exemplifications of the technique according to the present disclosure. However, the technique according to the present disclosure is not limited to the foregoing embodiments, and can also be applied to embodiments to which a change, substitution, addition, or omission is executed as necessary. For example, the following variation examples are also included in one embodiment of the present disclosure.

For example, although an example in which the ECU in which the primary dynamic authenticator is disposed is an integrated ECU has been described in the foregoing embodiments, the present disclosure is not limited to such. For example, the primary dynamic authenticator may be located in an ECU dedicated to the primary dynamic authenticator or in a gateway ECU.

For example, the present disclosure can be implemented not only as a vehicle security system, an integrated ECU (vehicle security device), or a zone ECU (vehicle security device), but also as a vehicle security method that includes steps (processing) performed by structural elements included in the vehicle security system, the integrated ECU, or the zone ECU.

For example, the present disclosure may be implemented as a program for causing a computer (processor) to execute the steps included in the vehicle security method. In addition, the present disclosure can be implemented as a non-transitory computer-readable recording medium such as a compact disc-read only memory (CD-ROM) including the program recorded thereon.

For example, when the present disclosure is implemented by a program (software), each of the steps is performed as a result of the program being executed by utilizing hardware resources such as a CPU, memory, an input and output circuit, etc. of a computer. In other words, each step is executed by the CPU obtaining data from memory or an input and output circuit, etc., performing calculations, and outputting calculation results to memory or input and output circuit, etc.

It should be noted that, in the foregoing embodiments, each of the structural elements included in the vehicle security system, the integrated ECU, and the zone ECUs may be configured as dedicated hardware, or may be implemented by executing a software program suitable for the structural element. Each of the structural elements may be realized by means of a program executing unit, such as a CPU or a processor, reading and executing the software program recorded on a recording medium such as a hard disk or a semiconductor memory.

Some or all of the functions of the vehicle security system, the integrated ECU, and the zone ECUs according to the foregoing embodiments are typically implemented as LSIs which are integrated circuits. They may be implemented as a single chip one-by-one, or as a single chip to include some or all thereof. In addition, the integrated circuit is not limited to an LSI, and it may be implemented as a dedicated circuit or a general-purpose processor. A field programmable gate array (FPGA) that is programmable after an LSI is manufactured or a reconfigurable processor that is capable of reconfiguring connection and settings of circuit cells inside an LSI may be employed.

Furthermore, in the future, with advancement in semiconductor technology, a brand-new technology may replace LSI. The structural elements included in the vehicle security system, the integrated ECU, and the zone ECUs each can be integrated using such a technology.

It should be noted that the present disclosure also includes other forms in which various modifications apparent to those skilled in the art are applied to the embodiments or forms in which structural elements and functions in the embodiments are arbitrarily combined within the scope of the present disclosure.

### (Others)

The descriptions of the embodiments described above disclose the following techniques.

(Technique 1) A vehicle security system provided in a vehicle, the vehicle security system including: a primary dynamic authenticator disposed in an electronic control unit (ECU) in the vehicle; and one or more connection managers. In the vehicle security system, when an access request for access to an access destination in the vehicle is made by an access source in the vehicle, the primary dynamic authenticator dynamically performs authentication of the access request based on a state of the vehicle, and causes a connection manager located on a communication path between the access source and the access destination, among the one or more connection managers, to control a connection between the access source and the access destination, based on a result of the authentication of the access request.

According to the above-described configuration, since the so-called zero trust architecture, which dynamically performs authentication of an access request; that is, authentication is performed for each access request on the assumption that a threat has already entered a vehicle, is applied to the vehicle, even if a threat has entered an in-vehicle network, it is possible to inhibit damage because the threat can be detected as a result of dynamically performing authentication of the access request. For example, it is possible to inhibit a vehicle which threat has entered from falling in a dangerous state, and to also inhibit an external network from being attacked due to a vehicle which threat has entered being used as a starting point for an attack on the external network. It should be noted that, access requests made by resources in a vehicle as the access sources may or may not be permitted depending on a state of the vehicle, and thus whether an access request is permissible is determined in consideration of the state of the vehicle.

(Technique 2) The vehicle security system according to Technique 1. In the vehicle security system, the primary dynamic authenticator: when determining that the state of the vehicle satisfies a predetermined condition, causes the connection manager located on the communication path between the access source and the access destination to connect the access source and the access destination; and when determining that the state of the vehicle no longer satisfies the predetermined condition, causes the connection manager located on the communication path between the access source and the access destination to disconnect the connection between the access source and the access destination.

According to the above-described configuration, the connection manager located on the communication path between an access source and an access destination is capable of controlling the connection between the access source and the access destination, and thus the primary dynamic authenticator is capable of controlling the connection between the access source and the access destination via the connection manager located on the communication path between the access source and the access destination, based on whether the state of the vehicle satisfies a predetermined condition.

(Technique 3) The vehicle security system according to Technique 2. In the vehicle security system, when determining that the state of the vehicle no longer satisfies the predetermined condition, the primary dynamic authenticator once again performs authentication of the access request, and causes the connection manager located on the communication path between the access source and the access destination to disconnect the connection between the access source and the access destination if the authentication of the access request once again performed fails.

According to the above-described configuration, since the primary dynamic authenticator once again performs authentication of the access request when determining that the state of the vehicle no longer satisfies the predetermined condition, it is possible to inhibit the connection between the access source and the access destination from being disconnected when the state of the vehicle temporarily changes and the state of the vehicle temporarily fails to satisfy the predetermined condition.

(Technique 4) The vehicle security system according to any one of Techniques 1 to 3. In the vehicle security system, the one or more connection managers include a connection manager disposed in the ECU in which the primary dynamic authenticator is disposed, and when the ECU in which the primary dynamic authenticator is disposed is located on the communication path between the access source and the access destination, the primary dynamic authenticator causes the connection manager disposed in the integrated ECU in which the primary dynamic authenticator is disposed to control the connection between the access source and the access destination.

In this manner, when an ECU in which a primary dynamic authenticator is disposed is located on the communication path between an access source and an access destination, the primary dynamic authenticator is capable of controlling the connection between the access source and the access destination via the connection manager disposed in the ECU in which the primary dynamic authenticator is disposed.

(Technique 5) The vehicle security system according to any one of Techniques 1 to 3. In the vehicle security system, the one or more connection managers include a connection manager disposed in a zone ECU in the vehicle, and when the zone ECU is located on the communication path between the access source and the access destination, the primary dynamic authenticator causes the connection manager disposed in the zone ECU to control the connection between the access source and the access destination.

In this manner, when a zone ECU is located on the communication path between an access source and an access destination, the primary dynamic authenticator is capable of controlling the connection between the access source and the access destination via the connection manager disposed in the zone ECU.

(Technique 6) The vehicle security system according to Technique 1, further including: a secondary dynamic authenticator disposed in a zone ECU in the vehicle. In the vehicle security system, when the zone ECU is located on the communication path between the access source and the access destination, the secondary dynamic authenticator, in response to the access request, dynamically performs authentication of the access request based on the state of the vehicle, and causes the connection manager located on the communication path between the access source and the access destination to control the connection between the access source and the access destination, based on a result of the authentication of the access request.

Access requests made by the resources in a vehicle include access requests related to controls that must be performed immediately, such as acceleration, deceleration, stopping, right turns, and left turns, which require high responsiveness in authentication of access requests. In view of the above, the vehicle security system includes a secondary dynamic authenticator disposed in the zone ECU, in addition to the primary dynamic authenticator. According to the above-described configuration, when the zone ECU is located on the communication path between an access source and an access destination, it is possible to perform authentication of an access request by the secondary dynamic authenticator in proximity to the access source. As a result, it is possible to improve the responsiveness in authentication of the access request.

(Technique 7) The vehicle security system according to Technique 6. In the vehicle security system, the secondary dynamic authenticator: when determining that the state of the vehicle satisfies a predetermined condition, causes the connection manager located on the communication path between the access source and the access destination to connect the access source and the access destination; and when determining that the state of the vehicle no longer satisfies the predetermined condition, causes the connection manager located on the communication path between the access source and the access destination to disconnect the connection between the access source and the access destination.

According to the above-described configuration, the connection manager located on the communication path between an access source and an access destination (e.g., a connection manager located between an access source and an access destination) is capable of controlling the connection between the access source and the access destination, and thus the secondary dynamic authenticator is capable of controlling the connection between the access source and the access destination via the connection manager located on the communication path between the access source and the access destination, based on whether the state of the vehicle satisfies a predetermined condition.

(Technique 8) The vehicle security system according to Technique 7. In the vehicle security system, when determining that the state of the vehicle no longer satisfies the predetermined condition, the secondary dynamic authenticator once again performs authentication of the access request, and causes the connection manager located on the communication path between the access source and the access destination to disconnect the connection between the access source and the access destination if the authentication of the access request once again performed fails.

According to the above-described configuration, since the secondary dynamic authenticator once again performs authentication of the access request when determining that the state of the vehicle no longer satisfies the predetermined condition, it is possible to inhibit the connection between the access source and the access destination from being disconnected when the state of the vehicle temporarily changes and the state of the vehicle temporarily fails to satisfy the predetermined condition.

(Technique 9) The vehicle security system according to any one of Techniques 6 to 8. In the vehicle security system, the one or more connection managers include a connection manager disposed in the zone ECU, and the secondary dynamic authenticator causes the connection manager disposed in the zone ECU to control the connection between the access source and the access destination.

In this manner, when a zone ECU is located on the communication path between an access source and an access destination, the secondary dynamic authenticator is capable of controlling the connection between the access source and the access destination via the connection manager disposed in the zone ECU.

(Technique 10) The vehicle security system according to any one of Techniques 6 to 9. In the vehicle security system, the ECU in which the primary dynamic authenticator is disposed and the zone ECU hold vehicle state information indicating the state of the vehicle, the primary dynamic authenticator causes the secondary dynamic authenticator to update, at a predetermined time, the vehicle state information held in the zone ECU with the vehicle state information held in the ECU in which the primary dynamic authenticator is disposed, and the secondary dynamic authenticator dynamically performs authentication of the access request based on the state of the vehicle indicated by the vehicle state information held in the zone ECU.

According to the above-described configuration, since the vehicle state information held in the zone ECU is updated at a predetermined time (e.g., periodically, when security information is updated, or when an anomaly occurs) with the latest vehicle state information held in the ECU in which the primary dynamic authenticator is disposed, the secondary dynamic authenticator is capable of performing authentication of an access request with high accuracy, using the vehicle state information that has been updated.

(Technique 11) The vehicle security system according to any one of Techniques 1 to 10. In the vehicle security system, the primary dynamic authenticator obtains vehicle state information indicating the state of the vehicle via any of the one or more connection managers.

According to the above-described configuration, when the primary dynamic authenticator obtains vehicle state information, authentication of an access request for access to a resource which holds the vehicle state information is also performed, and the vehicle state information is obtained via the connection manager. As a result, it is possible to improve security.

(Technique 12) The vehicle security system according to any one of Techniques 1 to 11. In the vehicle security system, the state of the vehicle includes a usage status of the access destination, a driving state of the vehicle, a security status of the access source, a security status of the access destination, a usage status of a service used in the vehicle, or a state of the access destination.

As described above, it is possible to determine whether an access request is permissible, in consideration of a usage status of the access destination, a driving state of the vehicle, a security status of the access source, a security status of the access destination, and a usage status of a service used in the vehicle.

(Technique 13) A vehicle security device provided in a vehicle, the vehicle security device including: a primary dynamic authenticator. In the vehicle security device, the primary dynamic authenticator dynamically performs, based on a state of the vehicle, authentication of an access request made by an access source in the vehicle for access to an access destination in the vehicle, and causes a connection manager located on a communication path between the access source and the access destination, among one or more connection managers disposed in the vehicle, to control a connection between the access source and the access destination, based on a result of the authentication of the access request.

According to the above-described configuration, it is possible to provide a vehicle security device capable of inhibiting damage even if a threat has entered an in-vehicle network.

(Technique 14) A vehicle security device provided in a vehicle, the vehicle security device including: a secondary dynamic authenticator. In the vehicle security device, when the vehicle security device is located on a communication path between an access source in the vehicle and an access destination in the vehicle, the secondary dynamic authenticator dynamically performs authentication of an access request made by the access source for access to the access destination, based on a state of the vehicle, and causes a connection manager located on the communication path between the access source and the access destination, among one or more connection managers disposed in the vehicle, to control a connection between the access source and the access destination, based on a result of the authentication of the access request.

According to the above-described configuration, it is possible to provide a vehicle security device capable of inhibiting damage even if a threat has entered an in-vehicle network.

While various embodiments have been described herein above, it is to be appreciated that various changes in form and detail may be made without departing from the spirit and scope of the present disclosure as presently or hereafter claimed.

Further Information about Technical Background to this Application

The disclosure of the following patent application including specification, drawings, and claims are incorporated herein by reference in their entirety: Japanese Patent Application No. 2023-091388 filed on Jun. 2, 2023.

### INDUSTRIAL APPLICABILITY

The present disclosure is applicable as, for example, an in-vehicle network, etc.

1. A vehicle security system provided in a vehicle, the vehicle security system comprising:
a primary dynamic authenticator disposed in an electronic control unit (ECU) in the vehicle; and
one or more connection managers, wherein
when an access request for access to an access destination in the vehicle is made by an access source in the vehicle, the primary dynamic authenticator dynamically performs authentication of the access request based on a state of the vehicle, and causes a connection manager located on a communication path between the access source and the access destination, among the one or more connection managers, to control a connection between the access source and the access destination, based on a result of the authentication of the access request.

2. The vehicle security system according to claim 1, wherein
the primary dynamic authenticator:
when determining that the state of the vehicle satisfies a predetermined condition, causes the connection manager located on the communication path between the access source and the access destination to connect the access source and the access destination; and
when determining that the state of the vehicle no longer satisfies the predetermined condition, causes the connection manager located on the communication path between the access source and the access destination to disconnect the connection between the access source and the access destination.

3. The vehicle security system according to claim 2, wherein
when determining that the state of the vehicle no longer satisfies the predetermined condition, the primary dynamic authenticator once again performs authentication of the access request, and causes the connection manager located on the communication path between the access source and the access destination to disconnect the connection between the access source and the access destination if the authentication of the access request once again performed fails.

4. The vehicle security system according to claim 1, wherein
the one or more connection managers include a connection manager disposed in the ECU in which the primary dynamic authenticator is disposed, and
when the ECU in which the primary dynamic authenticator is disposed is located on the communication path between the access source and the access destination, the primary dynamic authenticator causes the connection manager disposed in the ECU in which the primary dynamic authenticator is disposed to control the connection between the access source and the access destination.

5. The vehicle security system according to claim 1, wherein
the one or more connection managers include a connection manager disposed in a zone ECU in the vehicle, and
when the zone ECU is located on the communication path between the access source and the access destination, the primary dynamic authenticator causes the connection manager disposed in the zone ECU to control the connection between the access source and the access destination.

6. The vehicle security system according to claim 1, further comprising:
a secondary dynamic authenticator disposed in a zone ECU in the vehicle, wherein
when the zone ECU is located on the communication path between the access source and the access destination, the secondary dynamic authenticator, in response to the access request, dynamically performs authentication of the access request based on the state of the vehicle, and causes the connection manager located on the communication path between the access source and the access destination to control the connection between the access source and the access destination, based on a result of the authentication of the access request.

7. The vehicle security system according to claim 6, wherein
the secondary dynamic authenticator:
when determining that the state of the vehicle satisfies a predetermined condition, causes the connection manager located on the communication path between the access source and the access destination to connect the access source and the access destination; and
when determining that the state of the vehicle no longer satisfies the predetermined condition, causes the connection manager located on the communication path between the access source and the access destination to disconnect the connection between the access source and the access destination.

8. The vehicle security system according to claim 7, wherein
when determining that the state of the vehicle no longer satisfies the predetermined condition, the secondary dynamic authenticator once again performs authentication of the access request, and causes the connection manager located on the communication path between the access source and the access destination to disconnect the connection between the access source and the access destination if the authentication of the access request once again performed fails.

9. The vehicle security system according to claim 6, wherein
the one or more connection managers include a connection manager disposed in the zone ECU, and
the secondary dynamic authenticator causes the connection manager disposed in the zone ECU to control the connection between the access source and the access destination.

10. The vehicle security system according to claim 6, wherein
the ECU in which the primary dynamic authenticator is disposed and the zone ECU hold vehicle state information indicating the state of the vehicle,
the primary dynamic authenticator causes the secondary dynamic authenticator to update, at a predetermined time, the vehicle state information held in the zone ECU with the vehicle state information held in the ECU in which the primary dynamic authenticator is disposed, and
the secondary dynamic authenticator dynamically performs authentication of the access request based on the state of the vehicle indicated by the vehicle state information held in the zone ECU.

11. The vehicle security system according to claim 1, wherein
the primary dynamic authenticator obtains vehicle state information indicating the state of the vehicle via any of the one or more connection managers.

12. The vehicle security system according to claim 1, wherein
the state of the vehicle includes a usage status of the access destination, a driving state of the vehicle, a security status of the access source, a security status of the access destination, a usage status of a service used in the vehicle, or a state of the access destination.

13. A vehicle security device provided in a vehicle, the vehicle security device comprising:
a primary dynamic authenticator, wherein
the primary dynamic authenticator dynamically performs, based on a state of the vehicle, authentication of an access request made by an access source in the vehicle for access to an access destination in the vehicle, and causes a connection manager located on a communication path between the access source and the access destination, among one or more connection managers disposed in the vehicle, to control a connection between the access source and the access destination, based on a result of the authentication of the access request.

14. A vehicle security device provided in a vehicle, the vehicle security device comprising:
a secondary dynamic authenticator, wherein
when the vehicle security device is located on a communication path between an access source in the vehicle and an access destination in the vehicle, the secondary dynamic authenticator dynamically performs authentication of an access request made by the access source for access to the access destination, based on a state of the vehicle, and causes a connection manager located on the communication path between the access source and the access destination, among one or more connection managers disposed in the vehicle, to control a connection between the access source and the access destination, based on a result of the authentication of the access request.
